(19) United States
(12) Patent Application Publication
(10) Pub. No.: US 2025/0224319 A1
(43) Pub. Date: Jul. 10, 2025

(54) APPARATUS AND METHOD FOR TESTING THE SHARPNESS OF A CUTTING EDGE OF A BLADE

(71) Applicant: R.D.M. SOLUTIONS MANIAGO S.R.L.S., Maniago, Pordenone (IT)

(72) Inventor: Alessandro BISUTTI, San Giorgio Della Richinvelda (IT)

(73) Assignee: R.D.M. SOLUTIONS MANIAGO S.R.L.S., Maniago, Pordenone (IT)

(21) Appl. No.: 18/846,805

(22) PCT Filed: May 2, 2023
(86) PCT No.: PCT/IB2023/054538

§ 371 Date: Sep. 13, 2024

(30) Foreign Application Priority Data
May 12, 2022 (IT) 102022000009887

(51) Int. Cl. G01N 3/58; G01N 3/06

(52) U.S. Cl. CPC G01N 3/58; G01N 3/066

(57) ABSTRACT

An apparatus for testing the sharpness of a cutting edge of a blade by cutting a test body includes at least: first support means adapted to support said blade, second support means adapted to support said test body, said first and second support means being arranged and configured so that said test body lies on the cutting edge of said blade, displacing means adapted to carry out a relative sliding between said blade and said test body along said cutting edge with the simultaneous application of a cutting force on the cutting edge of said blade adapted to perform a cut on said test body, first detection means adapted to instantaneously detect a cutting force, and second detection means adapted to instantaneously detect the depth of the cut performed in the test body.

### TECHNICAL FIELD OF THE INVENTION

The present invention relates to an apparatus for testing/evaluating the sharpness of a sharpened edge of blades of cutting tools such as for example knives, scissors, scalpels, cutters, razor blades or the like. Furthermore, the present invention relates to a method for testing the sharpness of a sharpened edge of blades of cutting tools.

### BACKGROUND OF THE INVENTION

A need that is particularly felt both by producers and users of cutting tools lies in being able to test and possibly certify the sharpness of a blade, that is the cutting ability thereof. As a matter of fact, for producers of cutting tools it would be desirable to be able to classify the blades based on their cutting ability while for the users, in particular those using cutting tools daily, for example butchers, it is suitable to monitor that the blades used are well sharpened, and possibly sharpen them if they are not sharpened, so as to reduce the fatigue of the operators and avoid the onset of painful diseases on the upper limbs.

However, currently there is no index or unit of measurement which allows to express such characteristic, and not even a reference sample for comparing it.

There are known empiric tests to be carried out on the blades, however based on subjective and non-replicable parameters. For example, a method currently used is based on the cutting of a test body in particular a paper sheet, obtained by manually sliding it along the entire extension of the cutting edge of the blade and simultaneously pressing it towards the blade with a substantially constant force, evaluating—at the end of the test—the depth of the cut thus obtained in the test sheet. Clearly, such test depends on the sensitiveness and the ability of the operator who performs it and therefore cannot provide neither reliable nor replicable results.

Furthermore, there are apparatuses for testing the sharpness of the blade based on the cut of a portion of fabric which is picked up from a roll, for example as provided for in WO2017/142423. However, such device does not allow to certify the sharpness of the blade by providing evidence of the test carried out.

### SUMMARY OF THE INVENTION

The main task of the present invention is to provide an apparatus and relative operative method, for testing the sharpness of the cutting edge of a blade which provides objective and replicable results.

Within this task, an object of the present invention is to provide an apparatus for testing the sharpness of a blade which allows to provide a traceable certification of the test result.

Another object of the present invention is to provide an apparatus which allows to identify possible critical points along the blade, so as to be able to see to the prompt correction thereof.

Another object of the present invention is to provide an apparatus for testing the sharpness of a blade which can be used for testing blades with different lengths and shapes, providing-in output-information that is objective, precise and easy to interpret regarding the sharpness of the blade, which can be used to optimise the design of the blades, of the equipment and the techniques used to sharpen and to guarantee-to the users-that the sharpness of the blades meets determined standards.

Last but not least, an object of the present invention is to provide an apparatus that attains the task and objects mentioned above at competitive costs.

The aforementioned tasks and objects, as well as others which will be more apparent hereinafter, are attained by an apparatus as defined in claim 1 and by a method as provided for in claim 10.

### BRIEF DESCRIPTION OF THE FIGURES

Advantages and characteristics of the invention will be apparent from the following description, provided by way of non-limiting example, with reference to the attached figures, wherein:

FIG. 1 shows, with a front view, an apparatus for testing the sharpness of the cutting edge of a blade according to the present invention;

FIG. 2 shows, with a perspective view, a part of the apparatus according to FIG. 1;

FIG. 3 shows, in perspective view, a test body adapted to be mounted in the apparatus according to the previous figures for performing the cutting test;

FIGS. 4A and 4B show, in perspective view, means for supporting the test body of an apparatus according to the present invention, respectively in an opening position without the test body and in an opening position with the test body 20 inserted;

FIGS. 5A and 5B show two exemplifying charts relating to the sharpness of the cutting edge of a tested blade obtained as output from an apparatus according to the present invention.

### DETAILED DESCRIPTION OF THE INVENTION

The present invention relates to an apparatus 1 for testing the sharpness of a cutting edge 12 of a blade 11 of a cutting tool 10, such as for example a knife, based on the cutting of a test body 20 and obtained through the relative movement between the latter and the blade 11 along the extension of said cutting edge 12.

In particular, said tool 10 comprises at least one blade 11 provided, on one side, with a sharpened cutting edge 12, variously shaped, extending between a first end 12A, or heel end, and a second end 12B, or tip end, and—on the opposite side—with a spine 13 preferably not sharpened. Gripping means 14, such as a handle or a gripping element, may be possibly associated with the blade 12, preferably at the end of the heel 12A thereof.

According to an advantageous characteristic of the present invention, such apparatus 1 operates by making the blade 11 perform a cut on a single test body 20, that is formed by a discrete element, not coming from a roll or web of material, which can be removed and replaced to test each single blade.

As shown in FIG. 3, said test body 20 advantageously comprises an essentially flat support element 21, made of a material having a substantially homogeneous composition. In particular, preferably, said flat support member 21 is formed by a paper sheet or other material having the same even thickness and ease of cut properties. According to an advantageous characteristic of the present invention, said test

body 20 further comprises a conductive element 22 made of material that is electrically conductive and mechanically not harmful for the sharpening of the tested blade, associated with said support element 21. In particular, advantageously, said conductive element 22 is formed by a homogeneous electrically conductive layer which is applied and essentially entirely covers one of the two opposite surfaces of said support element 21. For example, said test body 20 may be formed by a conductive paper sheet.

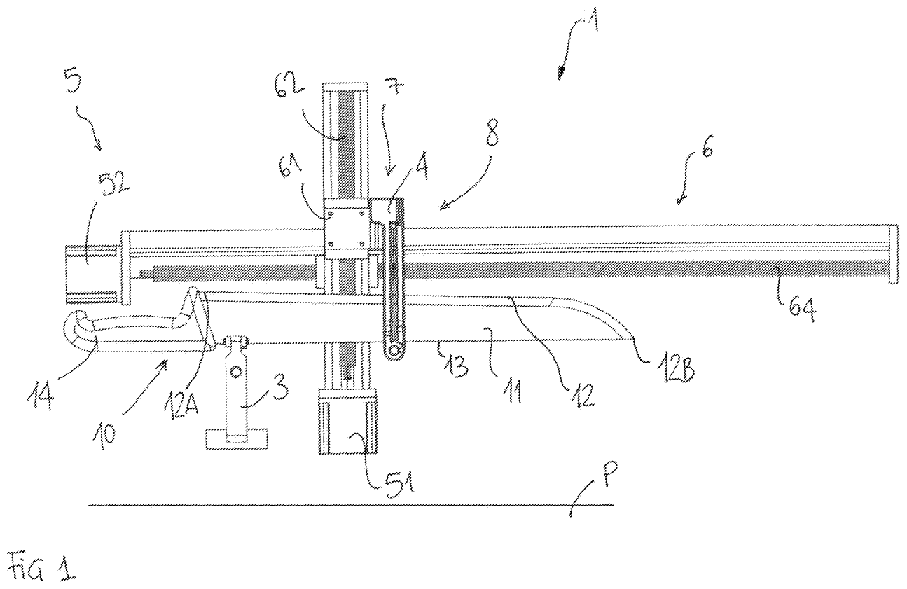

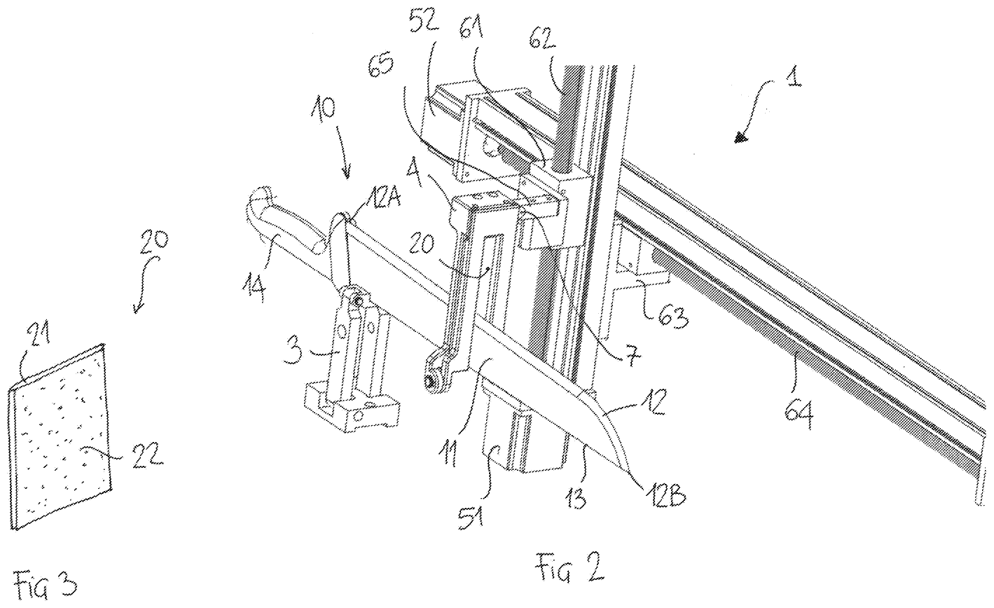

FIGS. 1 and 2 show an apparatus 1 for testing the sharpness of a cutting edge 12 of a blade 11 according to the present invention. Said apparatus 1 preferably comprises a support structure, not shown in the figures, adapted to be arranged on an essentially horizontal reference plane P, and comprising at least first support means 3, adapted to support said blade 11, and second support means 4 adapted to support said test body 20, said first and second support means 3, 4 being arranged and configured so that said test body 20 lies on the cutting edge 12 of said blade 11, that is it is kept constantly in contact therewith.

Said apparatus 1 further comprises displacing means 5 adapted to cause a relative displacement between said blade 11 and said test body 20 along said cutting edge 12, with the simultaneous application of a cutting force F on the cutting edge 12 adapted to perform a cut on said test body 20, essentially formed by a groove which propagates essentially vertically from a lower edge thereof, extending progressively towards a substantially central area.

In particular, when carrying out the test, the relative displacement is preferably carried out while keeping said blade 12, and therefore said first support means 3, in a fixed position, and moving said test body 20, mounted on said second support means 4, along the cutting edge 11 of the blade 12, advantageously over the entire extension thereof, preferably starting from the first end 12A and reaching the opposite end 12B.

Said first support means 3 are therefore adapted to support the blade 11 so that it remains in the same position during the entire execution of the test, in particular arranging the blade so that it lies along an essentially vertical plane, with said cutting edge 12 advantageously arranged upwards, being arranged at a height greater than the spine 13 with respect to the reference plane P. For example, said support means 3 may consist of a self-centring clamp on which said blade 11 is directly arranged.

Said second support means 4 are instead preferably adapted to support said test body 20 so that it lies on a plane that is essentially vertical and perpendicular with respect to the lying plane of said blade 11, so that—in an initial condition—the lower edge of the body 20 is positioned on the cutting edge 12, preferably at said first end 12A.

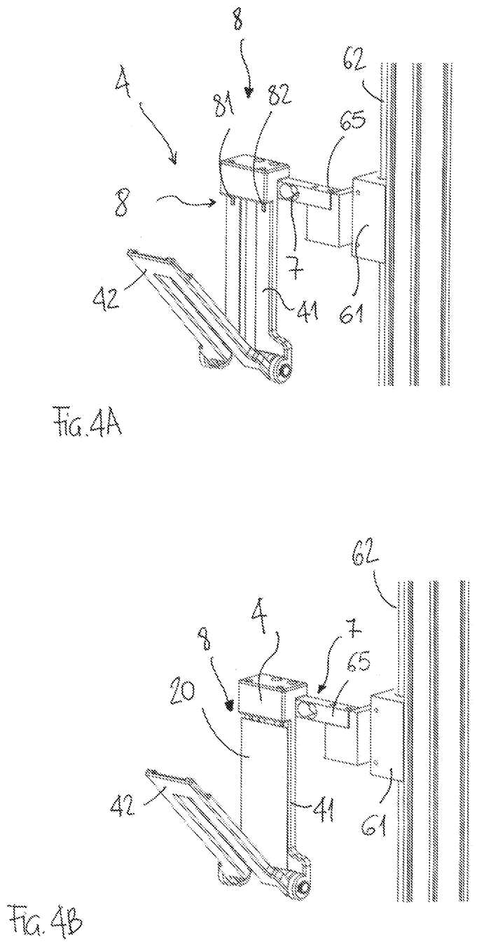

As observable in FIGS. 4A and 4B, said second support means 4 preferably comprise a fork-shaped clamp, advantageously made of electrical insulating material, formed by a fixed part 41 on which there is hinged a movable part 42, rotatably movable between an opening position, wherein it is moved away from said fixed part so as to allow to position the test body 20, and a closing position, wherein it substantially abuts against said fixed part 41 to retain the test body 20 in position.

Said fork-shaped clamp advantageously comprises a pair of parallel arms, adapted to be arranged, in use, astride the blade 11, and connected-at a top portion
by a horizontal fitting element. According to an embodiment of the present invention, said fixed part 41 and said movable part 42 have an identical shape and they are pivoted to each other through hinges arranged at the vacant ends of each arm of said pair of arms.

Advantageously, said displacing means 5 are configured so as to move said second support means 4, whereon there is arranged the test body 20, along the cutting edge 12 towards the tip end 12B, lying thereon with a force/pressure so that the blade 11 progressively penetrates into the test body 20 cutting it, that is progressively separating the two flaps thereof, in particular starting from the lower edge and proceeding towards a substantially central area thereof. Such configuration is advantageous given that it allows to improve the safety of the operators performing the test, given that there are no sharp blades in motion.

The movement of said second support means 4 is advantageously guided by guide means 6, also mounted on said support structure, and preferably formed by a first slide 61 associated-through a connection arm 65—with said second support means 4 and slidably mounted along a first rail 62, in turn mounted on a second slide 63 slidable along a second rail 64, wherein said rails 62, 64 extend along perpendicular axes.

In particular, preferably, said first rail 62 is arranged so as to extend along an axis substantially perpendicular to the reference plane P, and therefore vertical in use, while said second rail 64 is arranged so as to extend along an axis essentially parallel to the reference plane P, and therefore horizontal in use.

Said displacing means 5 are preferably formed by a first and a second stepper electric motor 51, 52, each operatively connected to a respective slide 61, 63. As a result, the relative position of the test body 20 with respect to the blade 11 is known moment by moment by the imparted micro-step.

Said apparatus 1 further comprises at least first detection means 7, adapted to instantaneously detect the force with which the test body 20 is pressed against said cutting edge 12, and second detection means 8 adapted to instantaneously detect the depth of the cut performed by the blade 12 into the test body 20, that is the extension thereof in the test body 20.

Advantageously, said first detection means 7 are formed by a load cell preferably mounted on said connection arm 65.

According to an advantageous characteristic of the present invention, said first and second detection means 7, 8 are adapted to operate when carrying out the test to provide information on the sharpness of the cutting edge 12 as a function of the force F and of the depth of the cut.

Clearly, the test is performed to detect the sharpness of at least one portion of the cutting edge 12 of the blade 11, and preferably over the entire extension thereof.

According to an advantageous characteristic of the present invention, said second detection means 8 are adapted to detect the depth of the cut performed by the blade 12 into the test body 20 indirectly, in particular by measuring an electromechanical parameter associated with the test body 20, in particular, advantageously, the change in the electrical resistance thereof.

To this end, advantageously, said second detection means 8 substantially comprise a pair of electrodes 81, 82 mounted on said support means 4 so as to be in contact with the conductive element 22 of the test body 20, that is with the electrical conductive layer which covers one of the two opposite surfaces of the support sheet 21.

The penetration of the blade 11 into the test body 20, that is the depth of the cut performed by the blade 12 in the test body 20, is inversely proportional to the electrical resistance detected by said second detection means 8.

As a matter of fact, the electrical resistance may be expressed as:

R=ρL/A,
wherein L is the distance between the two ends whose potential difference is known, that is the two electrodes 81, 82, A is the area of the section perpendicular to the potential gradient and p is the average electrical resistivity of the material between the electrodes 81, 82.

Given that A*R=K, and given that A=thickness*length, in which the thickness of the test body 20 is constant, as a result the length of the test body 20 not cut and the detected electrical resistance are inversely proportional.

As a result, constantly detecting the electrical resistance between the electrodes 81, 82 allows to obtain—indirectly and very precisely—the instantaneous depth of the cut performed by the blade 11 in the test body 20.

The sharpness of the blade is therefore a function of the measurement of the force detected to cut the test body 20 by a determined amount. As a matter of fact, the greater the force F required to cut the test body 20, the lesser the cutting ability of the cutting edge 12 of the blade 11, and this therefore indicates a defect of the blade 12 or the need to sharpen that specific portion of the cutting edge 11.

In other words, constantly measuring the electrical resistance of the test body 20 allows to know—in an extremely precise manner—the penetration depth of the blade 12 into the test body 20.

The apparatus 1 further comprises a command and control unit 100 including at least one processing unit (circuit board), to which there are operatively connected said displacing means 5 and said detection means 7, 8.

Advantageously, said command and control unit 100 receives and stores the information detected-instant by instant-by said first and second detection means 7, 8, that is the exerted force and the depth of the cut, together with the relative position between the blade 11 and the test body 20 provided by the displacing means 5, and processes them to provide information on the sharpness of the cutting edge 12 as a function of the detected parameters.

In particular, preferably, said command and control unit 100 generates a profile for the change in the force required to cut the test body 20 by a predetermined depth for each point along the extension of the cutting edge 12 in which the detection was carried out.

As a matter of fact, according to an advantageous characteristic of the present invention, given that the test body 20 is a finished element, that is discrete, not coming from a roll or continuous web, it is advantageous to perform the test imparting a determined depth to the cut in the test body when performing the test, continuously detecting and modulating—as a result—the force required to obtain it.

As a matter of fact, were one to proceed maintaining the force constant and instead detect the cutting depth, if the edge is very sharp the cut could reach the top edge of the test sheet 20 before the test is over, basically making the measurement ineffective and also potentially damaging parts of the apparatus 1, such as for example the second support means 4.

Said command and control unit 100 may therefore advantageously suitably actuate/control said displacing means 5 based on the data acquired, preferably so as to impart the desired cutting depth and follow the geometry of the edge 12 of the blade 11.

Therefore, preferably, said first and second detection means 7, 8 operate-in use-to determine the force required by the cutting edge 12 of the blade 11 to perform a cutting in the test body 20 having a determined depth. In other words, the soundness of the blade can be obtained by monitoring the force applied considering the same length of the cut carried out.

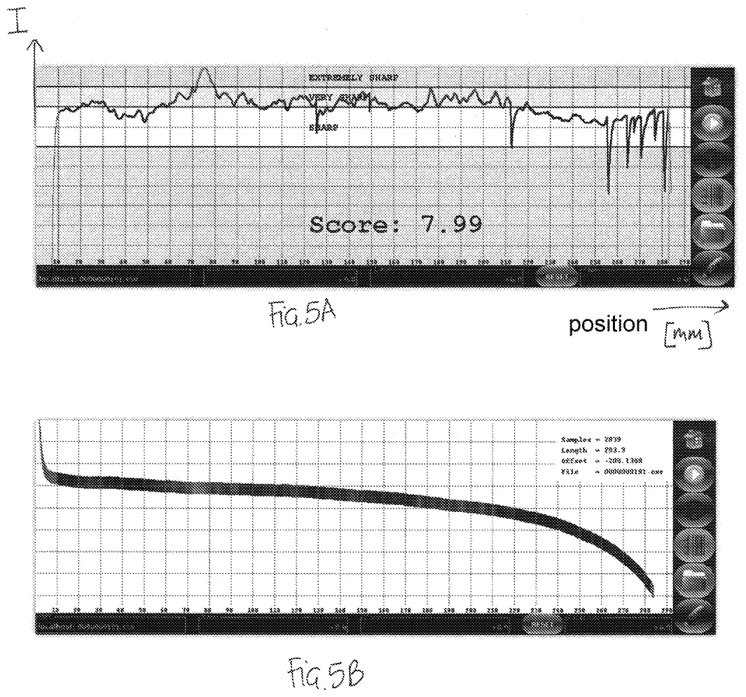

In output, the command and control unit 100 provides precise information on the sharpness of the edge 12 of the blade 11 preferably in the form of a chart, as shown in FIG. 5A by way of example, which shows—on the abscissa—the longitudinal extension of the blade 12, and—on the ordinate—an index I function of the force, on a logarithmic scale, and of the angle of incidence on the edge 12 to obtain a cut in the test body 20 having a determined depth. There are then established the ranges within which the value of such index I is deemed more or less acceptable, advantageously assigning identification colours to such ranges for an immediate visual feedback.

Advantageously, such information may also be indicated in a different chart, for example shown in FIG. 5B, in which there is recreated the geometric profile of the edge 12 of the blade 11, as reconstructed by the detections carried out-moment by moment-by the displacing means 5 and by the angle of incidence, and the colour relating to the value taken-point by point-by the index I so as to immediately and intuitively show the possible presence of edge portions not sharpened appropriately, which need to be sharpened. The faithful reconstruction of the profile of the blade 12 is carried out thanks to the data relating to the position, known thanks to the displacing means 5, combined with detections made on the test body 20 by said detection means 7, 8.

Advantageously, furthermore, at the end of the test it is possible to provide, together with the tested blade, the corresponding test body 20 showing the cut carried out during the test, so as to be able to provide a certification of the performed test. To this end, with each test body 20 there is advantageously associated a unique reference code which uniquely correlates it to the tested blade, for example a QR-code.

A method for testing the sharpness of the cutting edge 12 of a blade 11 with an apparatus 1 according to the present invention substantially comprises the following operating steps:
a) positioning a blade 11 and a test body 20 on respective support means 3, 4;
b) performing a relative movement between the blade 11 and the test body 20 along said cutting edge 12;
c) instantaneously detecting the force applied on the test body 20;
d) instantaneously detecting the cutting depth carried out by the blade 11 in the test body 20; and
e) providing information on the sharpness of the cutting edge 12 as a function of the data detected in steps c) and d).

In particular, advantageously, the cutting depth is indirectly detected in step d) by measuring an electromechanical parameter R associated with said test body 20, preferably consisting of the change in the electrical resistance R between two points of the test body 20, provided with an electrical conductive element 22 to this end.

Advantageously, said test body 20 is formed by a discrete element, which can be replaced for each tested blade, so as to able to provide for a step f) for providing the test body 20 as a certification of the test carried out.

Furthermore, preferably, the sharpness of the blade is obtained by detecting the force applied on the test body 20 to obtain a cut having a pre-established/set depth, that is considering the same length of the cut carried out. This may be obtained by controlling the relative movement between the blade 11 and the test body 20 along said cutting edge 12. This advantageously allows to prevent—should the blade 11 be particularly long and/or the edge 12 be very sharp—the cut from reaching the top edge of the test sheet 20 before the test has been completed, therefore making the measurement ineffective and potentially damaging parts of the apparatus 1, such as for example the second support means 4.

Therefore, it is clear that the present invention allows to achieve the task and the objects initially provided for. As a matter of fact, there has been designed an apparatus, and a relative operative method, capable of testing the sharpness of the cutting edge of a blade providing objective and replicable results.

Furthermore, an apparatus according to the present invention provides a traceable certification of the result of the test: as a matter of fact, the test is carried out on a test body formed by a single element, which can be removed at the end of the test and representing a tangible evidence that the test was carried out.

Advantageously, an apparatus according to the present invention allows to identify possible critical points along the blade, so as to be able to correct them.

Furthermore, an apparatus for testing the sharpness of a blade according to the present invention can be used for testing blades with different lengths and shapes, providing-in output-information that is objective, precise and easy to interpret, which can be used to optimise the design of the blades, of the equipment and of the techniques used to sharpen or to guarantee-to the users-that the sharpness of the blades meets determined standards.

Lastly, it is clear that the apparatus of the present invention guarantees the safety of the operators designated to carry out the test, not providing for the movement of the blades during the test.

The objectives listed above are also achieved with a cost-effective apparatus, which does not provide for sophisticated optical reading means, obtaining the detection of the depth of the cut carried out in the test body 20 in a quick but indirect manner, by measuring the change in the electrical resistance of the test body 20, suitably provided with a conductive element 22 on the surface to this end.

In the description outlined above, terms such as “above”, “beneath”, “upper”, “lower”, “high”, “low” or the like refer to an apparatus 1 in its normal operative configuration, that is in use, as shown in the attached figures.

Obviously, the present invention is susceptible of numerous applications, modifications or variations without departing from the scope of protection, as defined in the attached claims.

Furthermore, the materials and equipment used to implement the present invention, as well as the shapes and dimensions of the individual components, may be the most suitable depending on the specific requirements.

1. An apparatus for testing the sharpness of a cutting edge of a blade by cutting a test body, said apparatus comprising at least:
first support means adapted to support said blade,
second support means adapted to support said test body, said first and second support means being arranged and configured so that said test body lies on the cutting edge of said blade,
displacing means adapted to carry out a relative sliding movement between said blade and said test body along said cutting edge with the simultaneous application of a cutting force on said cutting edge of said blade adapted to perform a cut on said test body,
first detection means adapted to instantaneously detect the cutting force, and
second detection means adapted to instantaneously detect the depth of the cut carried out in the test body,
said first and second detection means being adapted to operate, in use, to provide information on the sharpness of said cutting edge as a function of the cutting force and the depth of the cut.

2. The apparatus according to claim 1, wherein said second detection means are adapted to instantaneously detect the depth of the cut indirectly performed in the test body by measuring an electromechanical parameter associated with said test body.

3. The apparatus according to claim 1, wherein said test body comprises a conductive element, said second detection means comprising a pair of electrodes arranged so as to be in contact with said conductive element and being adapted to detect the change in the electrical resistance between said electrodes.

4. The apparatus according to claim 3, wherein said test body is formed by a discrete element, which can be replaced at each test, comprising a flat support member having an even thickness, said conductive element being applied homogeneously on a surface of said flat support member.

5. The apparatus according to claim 1, further comprising command and control unit operatively connected at least to said first detection means, to said second detection means and to said displacing means to acquire and store information respectively relating to the cutting force applied, the depth of the cut and the position of said test body with respect to said blade, and for controlling said displacing means.

6. The apparatus according to claim 1, wherein said first support means are adapted to support the blade so that, in use, it remains in the same position, lying along an essentially vertical plane, said displacing means being configured to displace said second support means so that said test body slides, in use, along said cutting edge.

7. The apparatus according to claim 1, wherein said second support means are adapted to support said test body so that, in use, it lies on an essentially vertical plane, and perpendicular with respect to a lying plane of said blade, so that in an initial condition a lower edge of the test body is positioned on said cutting edge.

8. The apparatus according to claim 1, wherein said second support means comprise a fork-shaped clamp formed by a fixed part on which a movable part is hinged, said movable part being rotatably movable between an opening position, in which it is moved away from said fixed part to allow the positioning of said test body, and a closing position, in which it substantially abuts against said fixed part to hold said test body in position.

9. The apparatus according to claim 6, wherein the movement of said second support means is guided by guide means formed by a first slide associated—through a connection arm—with said second support means and slidably mounted along a first rail, in turn mounted on a second slide slidable along a second rail, wherein said rails extend along perpendicular axes.

10. A method for testing the sharpness of a cutting edge of a blade by cutting a test body by means of an apparatus according to claim 1, comprising the following steps:
a) providing said blade and said test body on respective support means so that said test body lies on the cutting edge of said blade;
b) carrying out a relative sliding movement between said blade and said test body along said cutting edge;
c) instantaneously detecting the cutting force applied on the cutting edge of said blade in order to perform a cut on said test body;
d) instantaneously detecting the depth of said cut performed by the blade on said test body, and
e) providing information on the sharpness of the cutting edge as a function of the parameters detected in steps c) and d).

11. Method according to claim 10, wherein the sharpness of the cutting edge is evaluated by detecting the cutting force required to obtain a cut in the test body having a set depth.

12. Method according to claim 10, wherein said step d) is carried out by measuring the change in the electrical resistance between two points of said test body, the latter comprising a conductive element.
